(19) United States
(12) Patent Application Publication
(10) Pub. No.: US 2011/0216397 A1
(43) Pub. Date: Sep. 8, 2011

(54) INFRARED ZOOMING LENS

(76) Inventors: Kouji Kawaguchi, Saitama-shi (JP); Minoru Ando, Saitama-shi (JP)

(21) Appl. No.: 13/039,569

(22) Filed: Mar. 3, 2011

(30) Foreign Application Priority Data
Mar. 5, 2010 (JP) 2010-049446

(51) Int. Cl. G02B 13/14

(52) U.S. Cl. 359/357

(57) ABSTRACT

The present invention is directed to an infrared zoom lens that has one or more of its lens pieces made of chalcogenide tractable in processing such as press-molding, grinding, and the like, so as to facilitate compensating for spherical aberration that is generally hard to do, thereby producing a clear and vivid image. The infrared zoom lens has first to fourth lens elements arranged in series from the foremost position closest to the object; each of the first to fourth lens elements being of a single lens piece, and at least one of the first to fourth elements is made of chalcogenide.

### FIELD OF THE INVENTION

The present invention relates to an infrared zoom lens of improved ability to compensate for spherical aberration and reduced manufacturing cost.

### BACKGROUND ART

Prior art infrared zoom lenses include a thermally insulated infrared zoom lens that has optical elements arranged in series from the foremost position closest to the object toward the focal point along the optical axis, namely, first to third lens elements in this sequence where the first lens element (12) has its first and second major surfaces opposed to each other to exhibit positive magnification power, the second lens element has its first and second major surfaces opposed to each other to exhibit negative magnification power, and the third lens element has its first and second major surfaces opposed to each other to exhibit positive magnification power. The first and third lens elements are made of a first substance while the second lens element alone is made of a second substance different from the first substance, and a variation in refractive index of the first substance due to a variation in its temperature (dn/dT) is smaller than that of the second substance, and either one or both of the second major surfaces of the first and third lens elements is formed in diffractive surface (see Patent Document 1 listed below).

Another prior art infrared zoom lens has first to third groups of lens pieces arranged in series from the foremost position closest to the object, and during the zooming, the first and third lens groups are essentially fixed while the second lens group alone are movable where each of the first to third lens groups has at least one lens piece made of zinc sulfide (see Patent Document 2).

Still anther prior art infrared zoom lens is that which incorporates optics dedicated to infrared rays raging 3 to 5 μm or 8 to 12 μm in waveband and which has five groups of lens pieces arranged in series from the foremost position closest to the object, namely, a first lens group consisting of one or two lens pieces to exhibit positive refractivity, a second lens group consisting of one or two lens pieces to exhibit negative refractivity, a third lens group of a single negative meniscus lens having its concave surface positioned closer to the object, a fourth lens group of a single convex lens piece, and a fifth lens group consisting of at least four lens pieces where the rearmost lens piece closest to the imaging field is a positive meniscus lens having its convex major surface faced toward the object; and during the zooming, the first, fourth and fifth lens groups are essentially fixed while the second and third lens groups are movable so that displacing the second lens group along the optical axis permits magnification rate to alter, and meanwhile, displacing the third lens group along the optical axis enables to correct the imaging point under the requirements as defined in the following formulae (1) to (3):

1.00<f₁/fᵣ (1)

f₂/fₜ<−0.40 (2)

0.35<f₅/fₜ<0.70 (3)

where fₜ is a focal length of the entire optics at the telephoto end, f₁ is the focal length of the first lens group, f₂ is the focal length of the first lens group, and f₅ is the focal length of the fifth lens group (see Patent Document 3).

### LIST OF THE CITED DOCUMENTS ON THE PRIOR ART

### Patent Document 1

Japanese Preliminary Publication of Unexamined Patent Application No. 2005-521918

### Patent Document 2

Japanese Preliminary Publication of Unexamined Patent Application No. 2007-264649

### Patent Document 3

Japanese Patent No. 3365606

Configured as in Patent Document 1, the infrared zoom lens having its first and third lens elements made of the first substance facilitates maintenance by virtue of simple and manageable storage of the lens substance but is prone to lead to a critical problem that such a zoom lens is troublesome in compensating for aberration. The infrared zoom lens configured as in Patent Document 1 also has a static focal mechanism, which means it conducts no dynamic focusing control and cannot be user friendly.

Configured as in Patent Document 2, the infrared zoom lens has all the lens pieces made of zinc sulfide, which is disadvantageous in that the substance of the lens pieces is expensive and intractable in processing such as molding, polishing, and so forth. In one embodiment of this type of the infrared zoom lens, zinc sulfide is used in combination with germanium. The substance of zinc sulfide which is of low refractive index (approximately 2.2) is disadvantageous in that it brings about difficulty in compensating for aberration.

Configured as in Patent Document 3, the infrared zoom lens incorporates nine to twelve of the lens pieces, which is disadvantageous in that such a zoom lens costs more to fabricate, and that the lens pieces absorb infrared rays more to resultantly produce a darker picture. In addition, a lens barrel of such a zoom lens should be increased in dimensions and more complicated in structure.

The present invention is made to overcome the aforementioned problems in the prior art infrared zoom lenses, and accordingly, it is an object of the present invention to provide the improved infrared zoom lens that has at least one of its lens pieces made of chalcogenide tractable in processing such as press-molding, polishing, and so forth so as to facilitate compensating for spherical aberration that is generally hard to do, thereby producing a clear and vivid image.

It is another object of the present invention to provide the improved infrared zoom lens that has the reduced number of lens pieces to implement a simple-structure and lightweight lens barrel and that has the lens pieces of the reduced absorbance of infrared rays so as to produce a bright image.

It is further another object of the present invention to provide the improved infrared zoom lens that is capable of compensating for aberration adequately throughout the zooming range.

### SUMMARY OF THE INVENTION

In one aspect of the present invention, an infrared lens has first to fourth lens elements arranged in series from the foremost position closest to the object; each of the lens elements being of a single lens piece, and at least one of the first to fourth lens elements being made of chalcogenide.

In another aspect of the present invention, an infrared lens has first to fourth lens elements arranged in series from the foremost position closest to the object; each of the first to fourth lens elements being of a single lens piece, at least one of the first to fourth lens elements being made of chalcogenide that meets requirements as defined in the following formulae:

2.4≦N≦3.9

where N is a refractive index of the chalcogenide for incident light ranging from 8 to 12 μm in wavelength.

Thus, in accordance with the present invention, since it has one or more of its lens pieces made of chalcogenide tractable in processing such as press-molding, polishing, and the like, the infrared zoom lens is useful to facilitate compensating for spherical aberration that is generally hard to do, resulting in producing a clear and vivid image.

Also, in accordance with the present invention, the infrared zoom lens has the reduced number of lens pieces so as to bring about a simple-structure and lightweight lens barrel, and it has the lens pieces of the reduced absorbance of infrared rays so as to produce a bright image.

Moreover, in accordance with the present invention, the infrared zoom lens is useful to compensate for aberration adequately throughout the zooming range.

The formulae 2.4≦N≦3.9 provide the requirements for infrared lens optics, especially for far infrared lens optics where a chalcogenide is used as a material of the lens piece(s). If exceeding the upper limit as defined in the formulae, the material of chalcogenide is equivalent to a material of germanium, which leads to problems of increase in manufacturing cost and reduction in tractability. If exceeding the lower limit as defined in the formulae, the lens piece of chalcogenide is more similar to a glass lens, which brings about an adverse effect of reduction in infrared ray transmittance.

The present invention may be exemplified in the following manners:

The infrared zoom lens has the first lens element of positive refractivity, the second lens element of negative refractivity, and the third lens element of positive refractivity.

Configured in this manner, the infrared zoom lens advantageously exhibits the reduced field curvature.

Alternatively, the infrared zoom lens may have the additional fourth lens element of positive refractivity.

Configured in this manner, the infrared zoom lens advantageously exhibits the reduced variation in aberration.

Further alternatively, the first lens element may be a positive meniscus lens.

Configured in this manner, the infrared zoom lens is useful to compensate adequately for spherical aberration and field curvature.

Alternatively, the third lens element may be a positive meniscus lens.

Configured in this manner, the infrared zoom lens is useful to compensate adequately for spherical aberration.

Alternatively, the fourth lens element may be a positive meniscus lens.

Configured in this manner, the infrared zoom lens advantageously exhibits the reduced variation in aberration throughout the zooming range.

Alternatively, at least one of surfaces of the lens pieces may be a diffractive surface, and/or the third lens element may have one of its major surfaces formed in the diffractive surface.

Configured in this manner, the infrared zoom lens is useful to facilitate compensating for spherical aberration that is generally hard to do.

Alternatively, the first lens element stays still in its fixed position while the second lens element and the succeeding and trailing lens elements are movable so as to vary a magnification rate.

Configured in this manner, the infrared zoom lens facilitates simplifying a structure of the lens barrel and exhibits superior ability to compensate for aberration.

Alternatively, the first and third lens elements stay still in their respective fixed positions while the second and fourth lens elements are movable so as to vary a magnification rate.

Configured in this manner, the infrared zoom lens advantageously reduces variation in aberration throughout the zooming range.

Further alternatively, the fourth lens element is moved for the focusing.

Configured in this manner, the infrared zoom lens may have the minimum number of lens pieces to effectively reduce variation in Aberration throughout the zooming range.

### BRIEF DESCRIPTION OF THE DRAWINGS

FIG. 1 is an optical diagram illustrating the behavior of a first preferred embodiment of an infrared zoom lens at wide-angle and telephoto, respectively, according to the present invention;

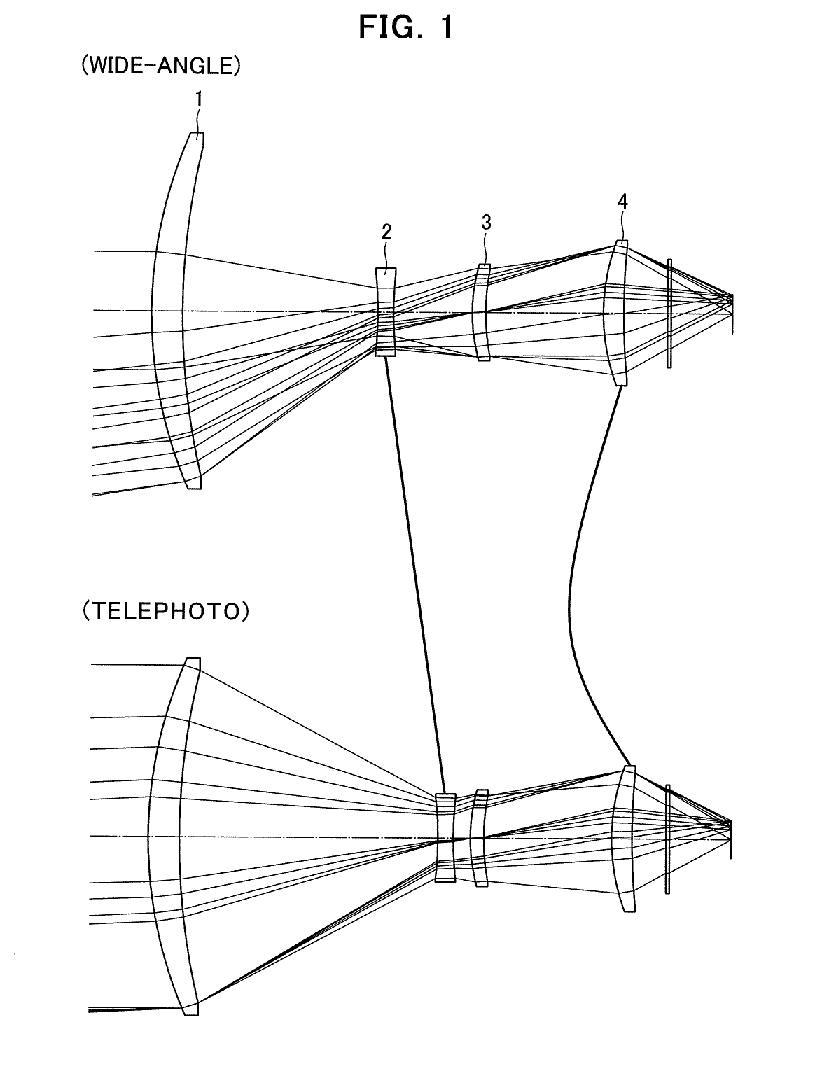

FIG. 2 is graphs on spherical aberration, astigmatism, and distortion aberration in the first preferred embodiment of the infrared zoom lens at wide-angle;

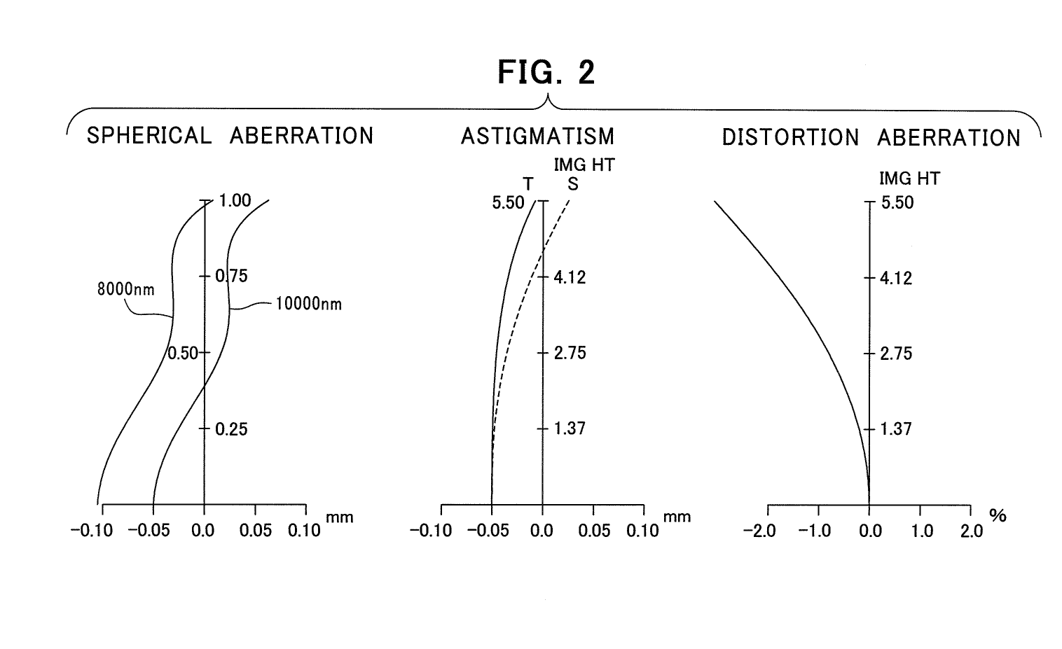

FIG. 3 is graphs on spherical aberration, astigmatism, and distortion aberration in the first preferred embodiment of the infrared zoom lens at telephoto;

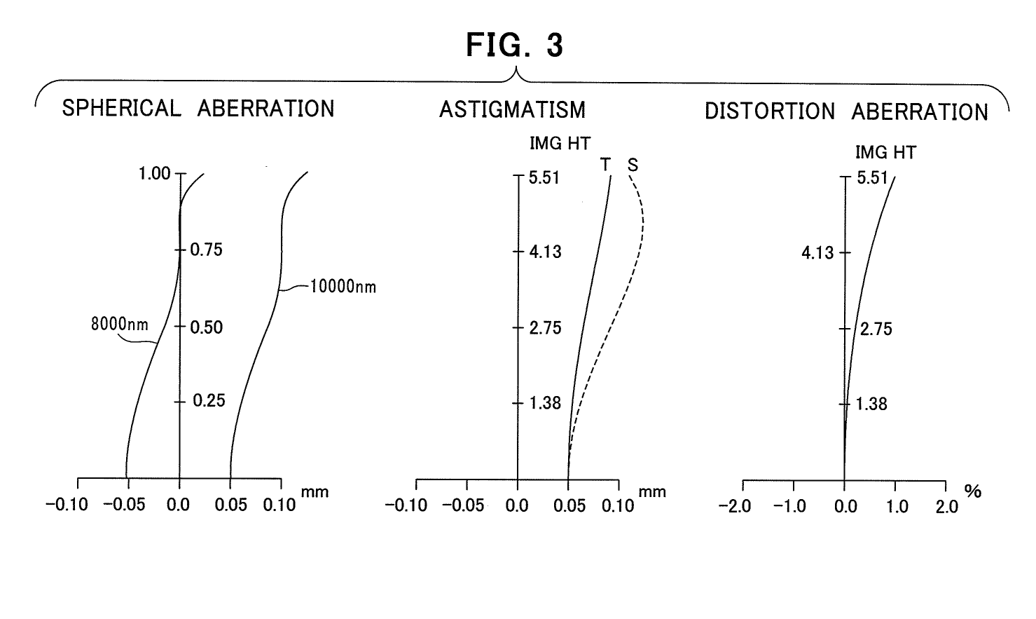

FIG. 4 is an optical diagram illustrating the behavior of a second preferred embodiment of the infrared zoom lens at wide-angle and telephoto, respectively, according to the present invention;

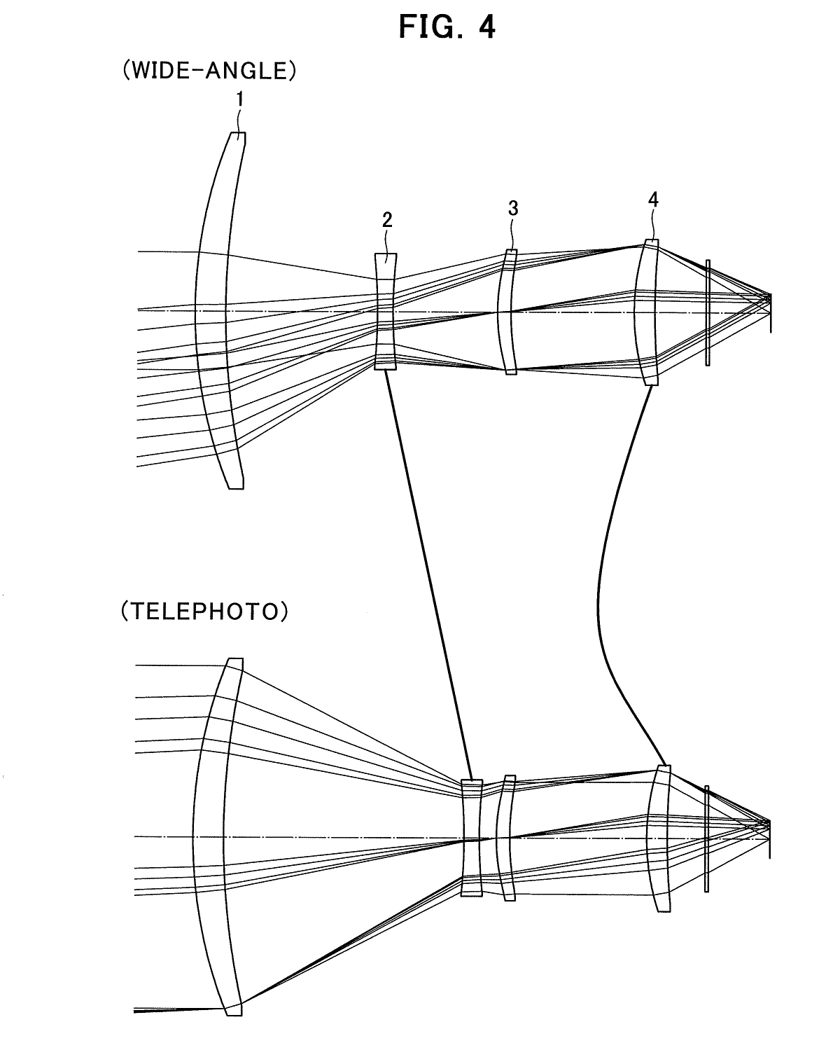

FIG. 5 is graphs on spherical aberration, astigmatism, and distortion aberration in the second preferred embodiment of the infrared zoom lens at wide-angle;

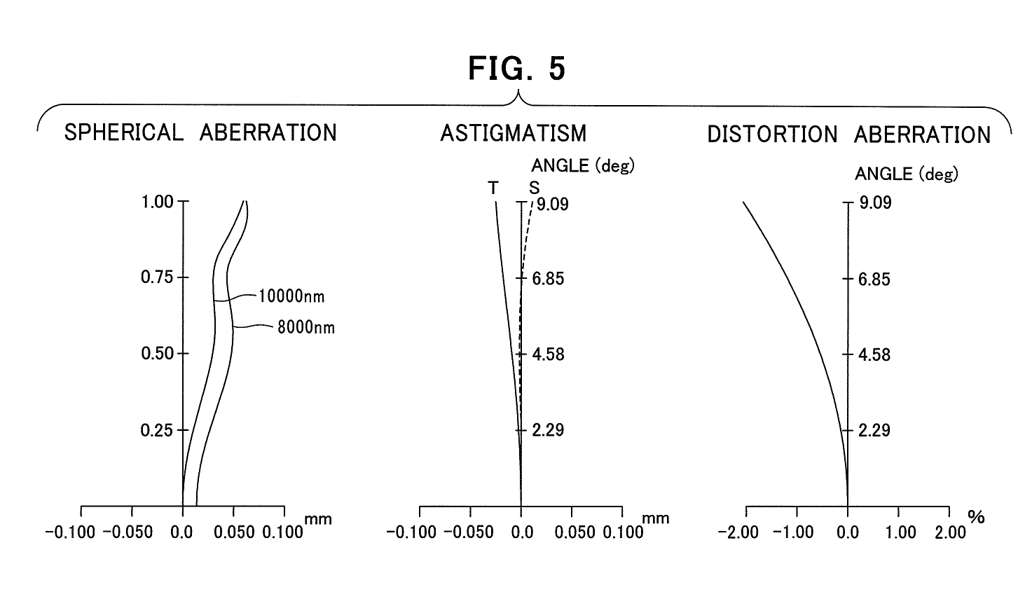

FIG. 6 is graphs on spherical aberration, astigmatism, and distortion aberration in the second preferred embodiment of the infrared zoom lens at telephoto;

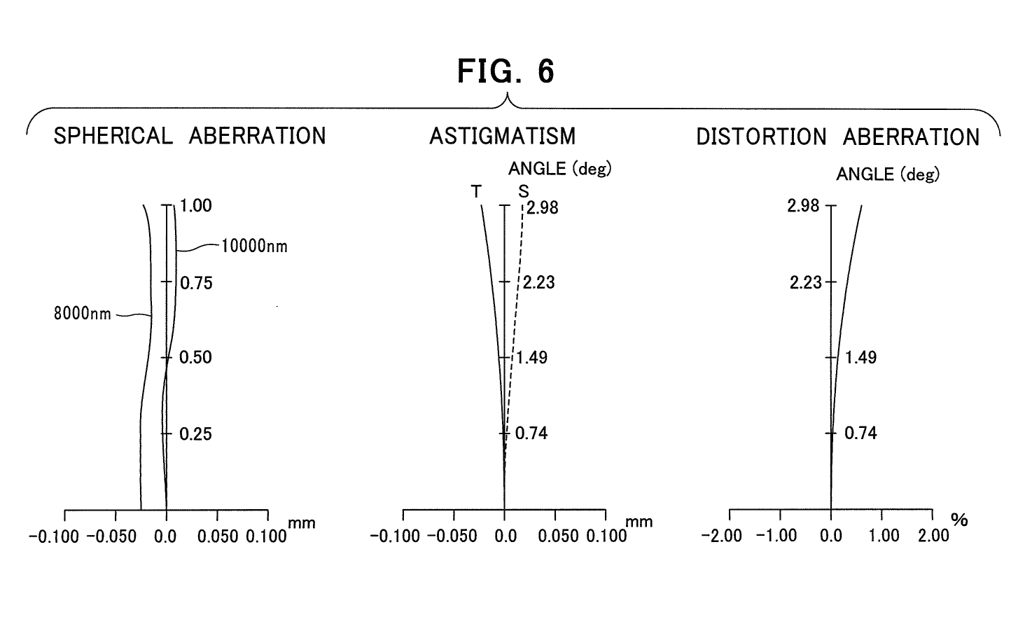

FIG. 7 is an optical diagram illustrating the behavior of a third preferred embodiment of the infrared zoom lens at wide-angle and telephoto, respectively, according to the present invention;

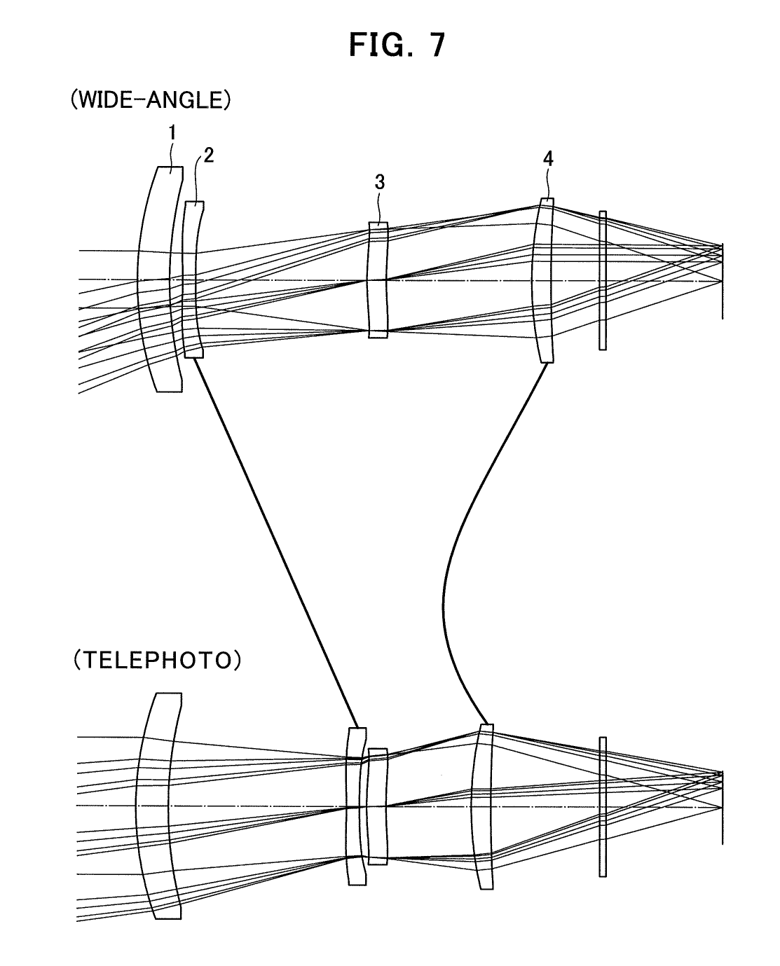

FIG. 8 is graphs on spherical aberration, astigmatism, and distortion aberration in the third preferred embodiment of the infrared zoom lens at wide-angle;

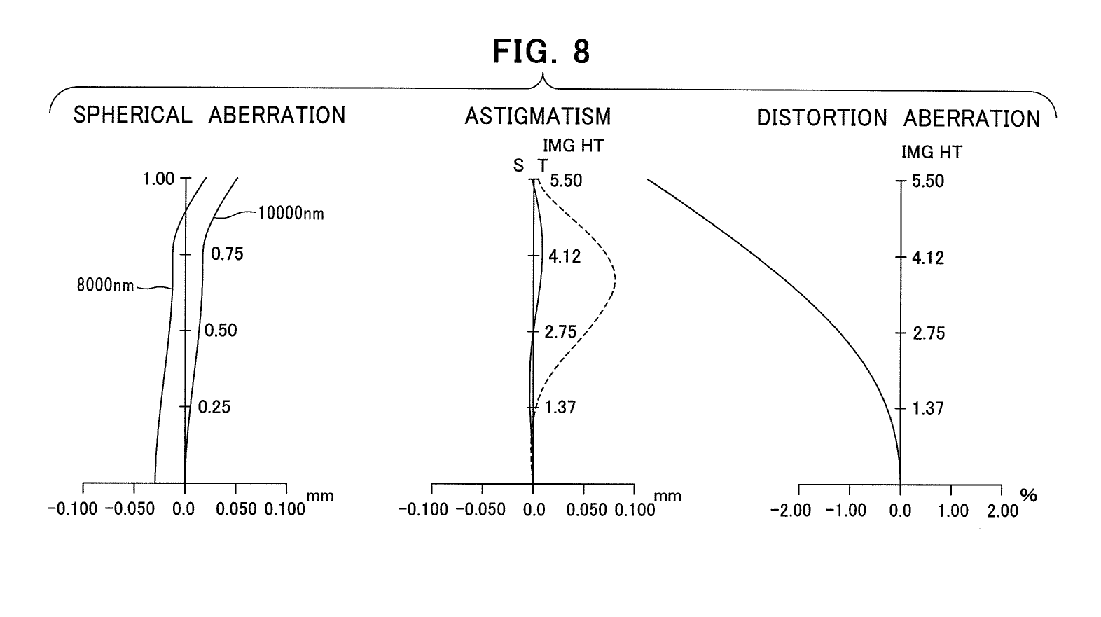

FIG. 9 is graphs on spherical aberration, astigmatism, and distortion aberration in the third preferred embodiment of the infrared zoom lens at telephoto;

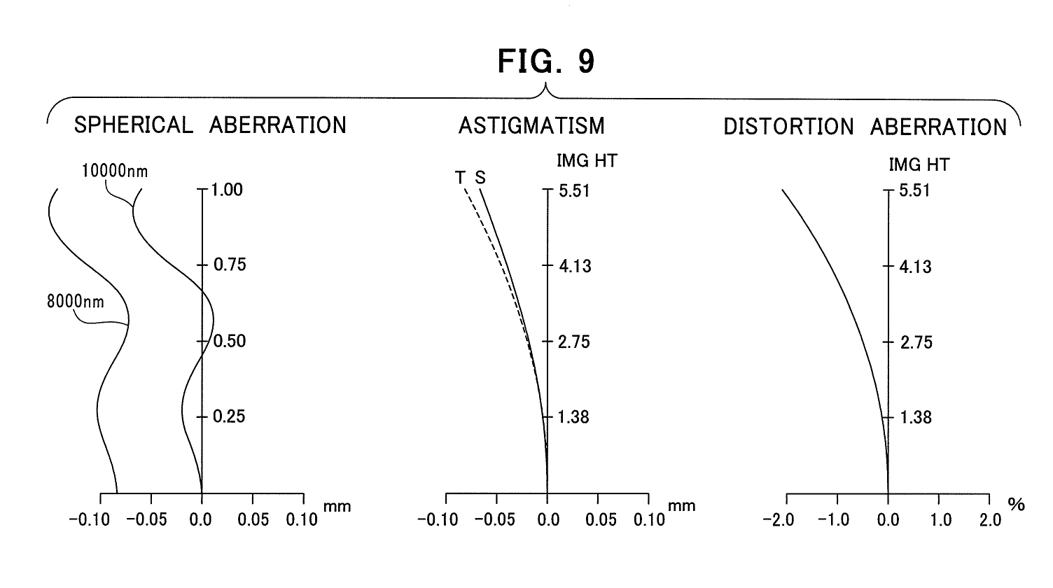

FIG. 10 is an optical diagram illustrating the behavior of a fourth preferred embodiment of the infrared zoom lens according to the present invention;

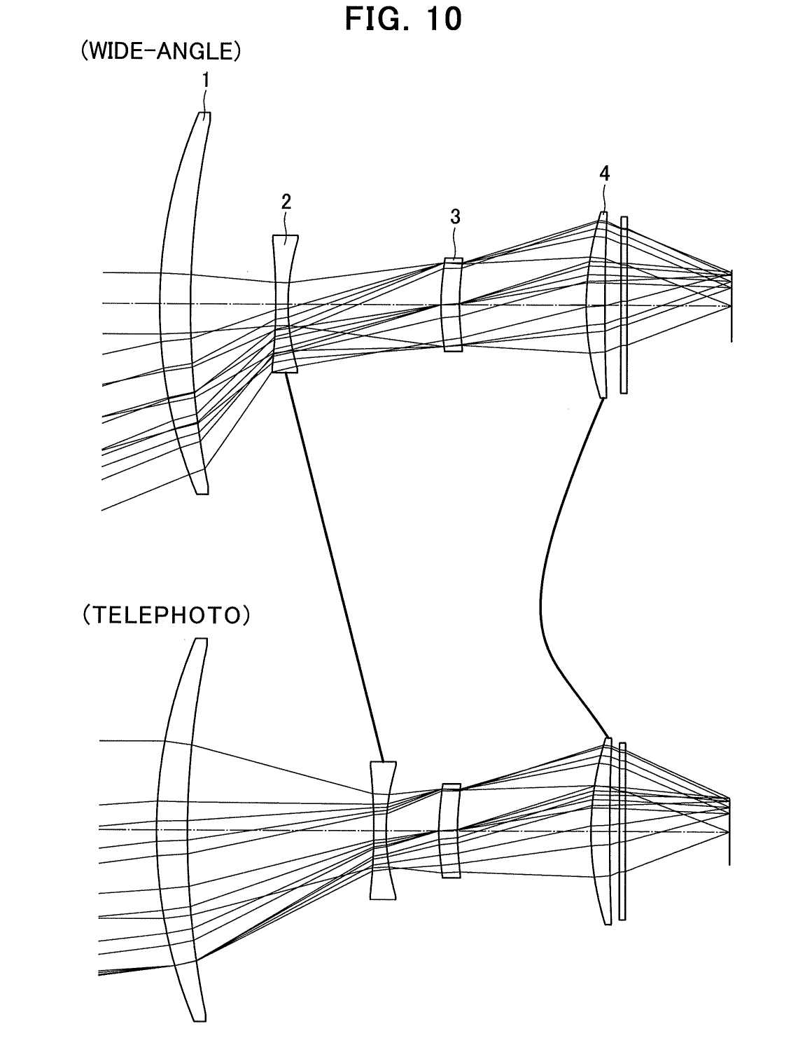

FIG. 11 is graphs on spherical aberration, astigmatism, distortion Aberration in the fourth preferred embodiment of the infrared zoom lens at wide-angle;

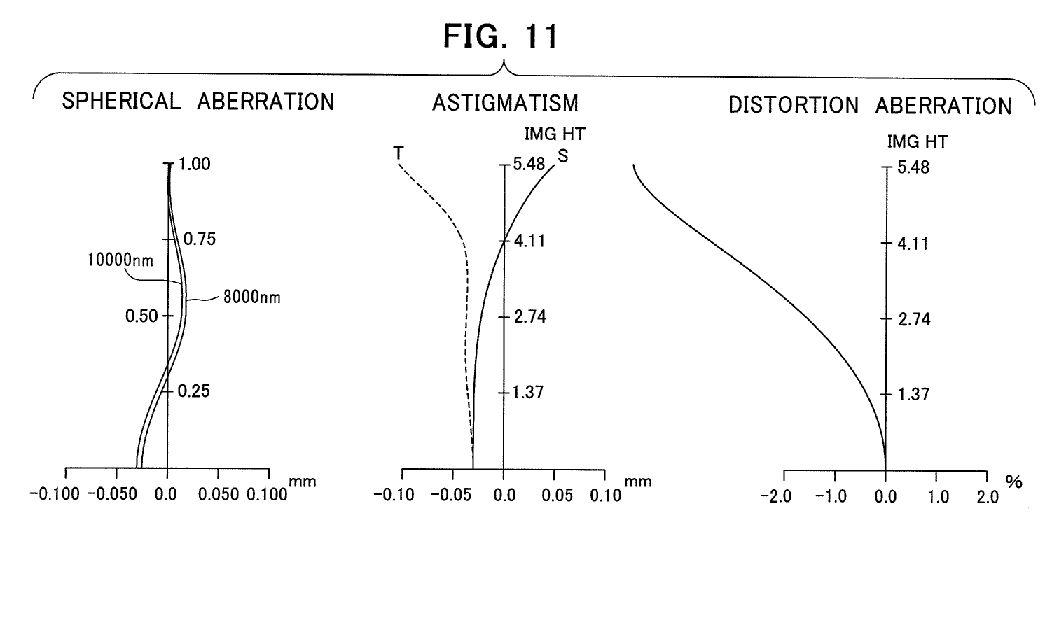

FIG. 12 is graphs on spherical aberration, astigmatism, distortion aberration in the fourth preferred embodiment of the infrared zoom lens at telephoto;

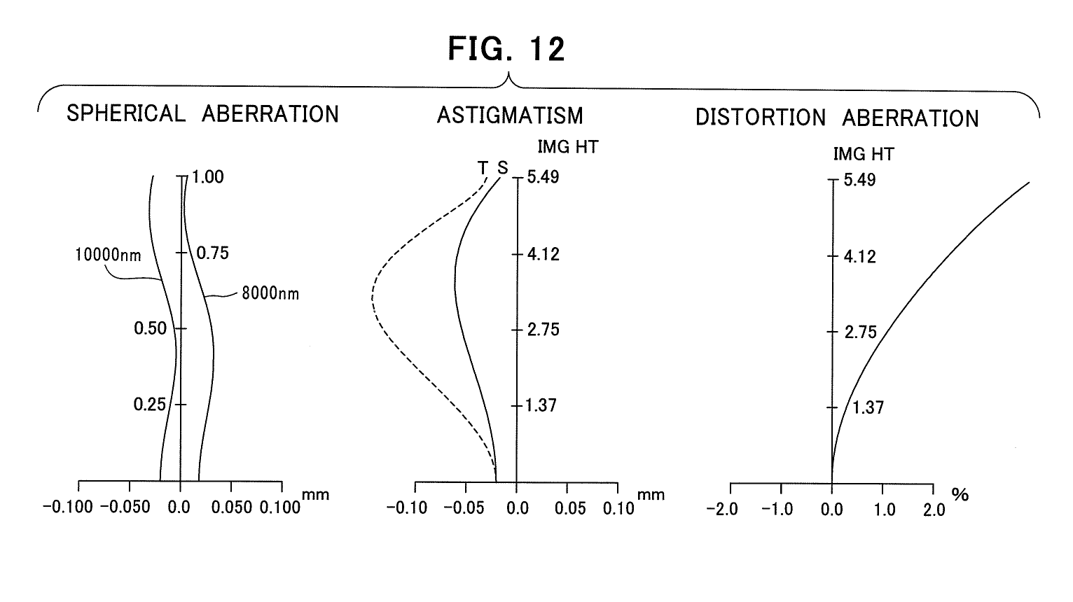

FIG. 13 is an optical diagram illustrating the behavior of a fifth preferred embodiment of the infrared zoom lens at wide-angle and telephoto, respectively, according to the present invention;

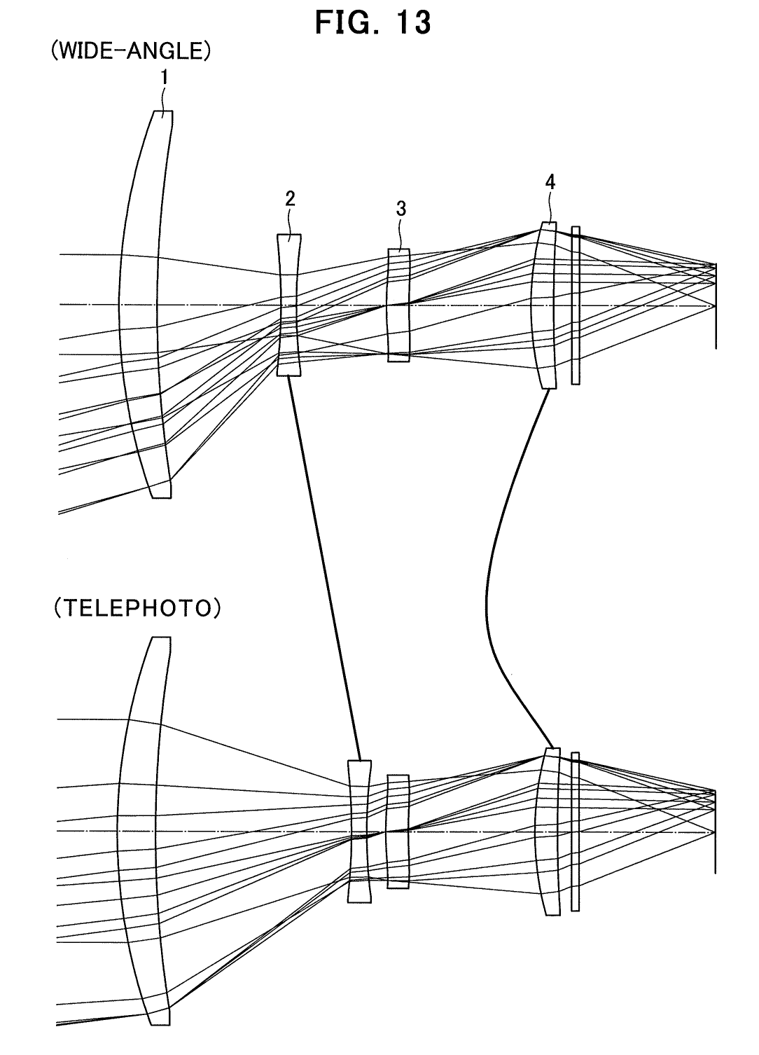

FIG. 14 is graphs on spherical aberration, astigmatism, and distortion aberration in the fifth preferred embodiment of the infrared zoom lens at wide-angle;

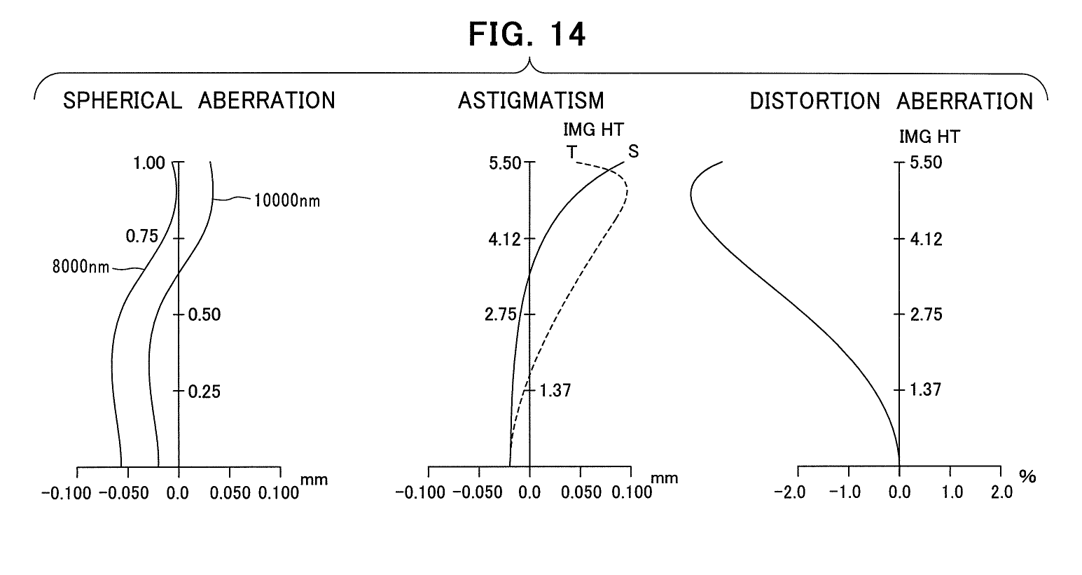

FIG. 15 is graphs on spherical aberration, astigmatism, and distortion aberration in the fifth preferred embodiment of the infrared zoom lens at telephoto;

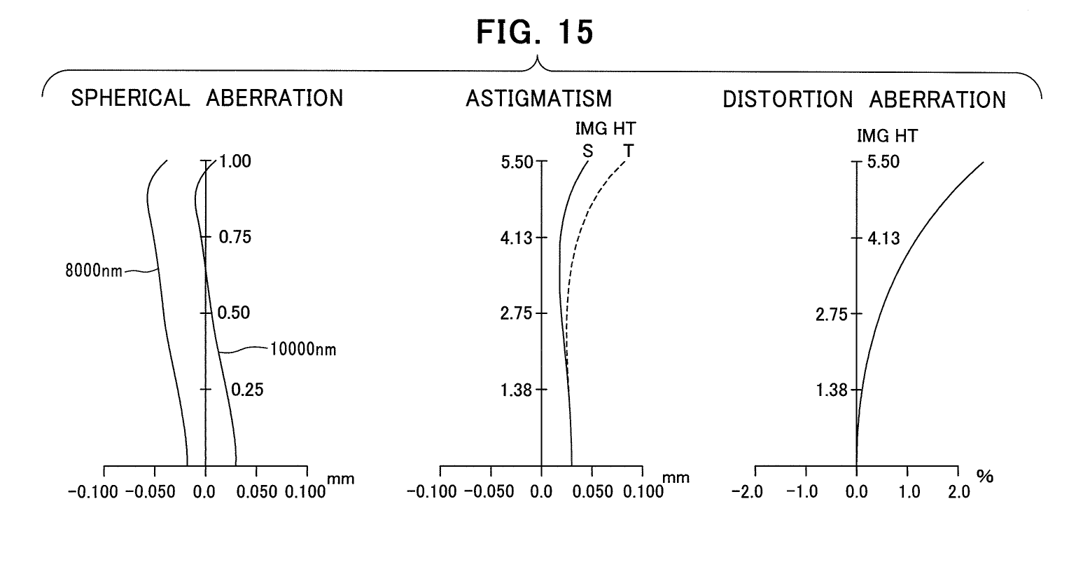

FIG. 16 is an optical diagram illustrating the behavior of a sixth preferred embodiment of the infrared zoom lens at wide-angle and telephoto, respectively, according to the present invention;

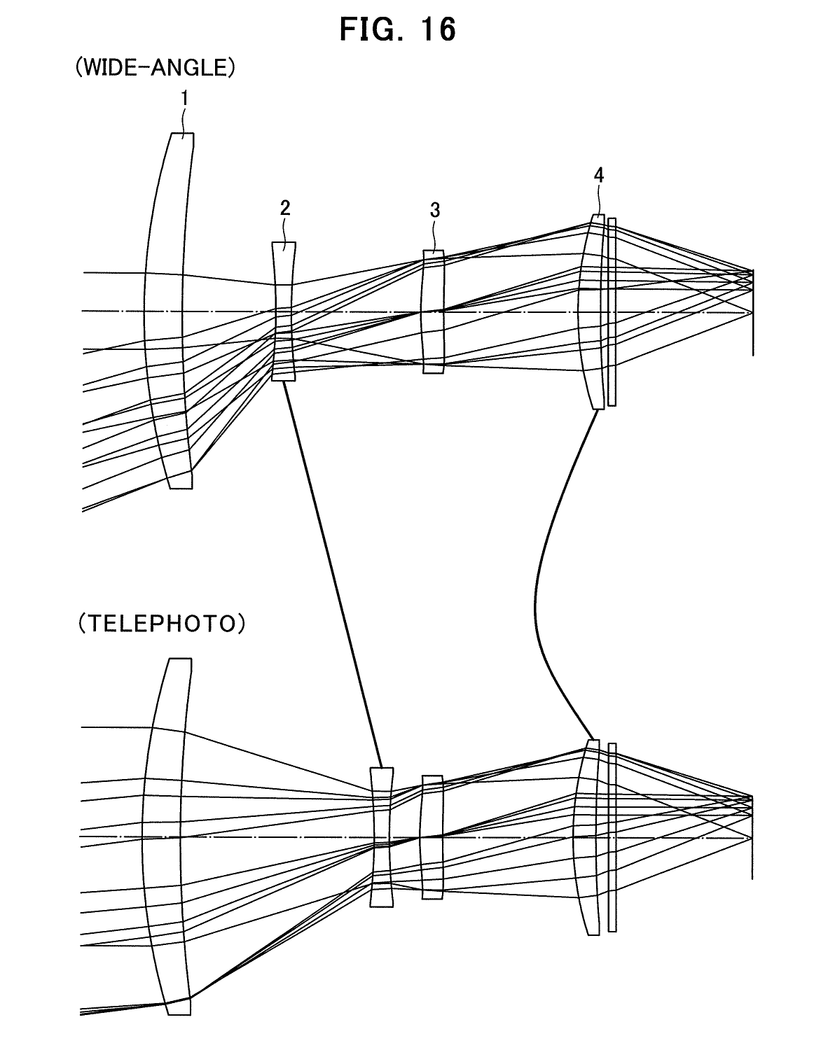

FIG. 17 is graphs on spherical aberration, astigmatism, and distortion aberration in the sixth preferred embodiment of the infrared zoom lens at wide-angle; and

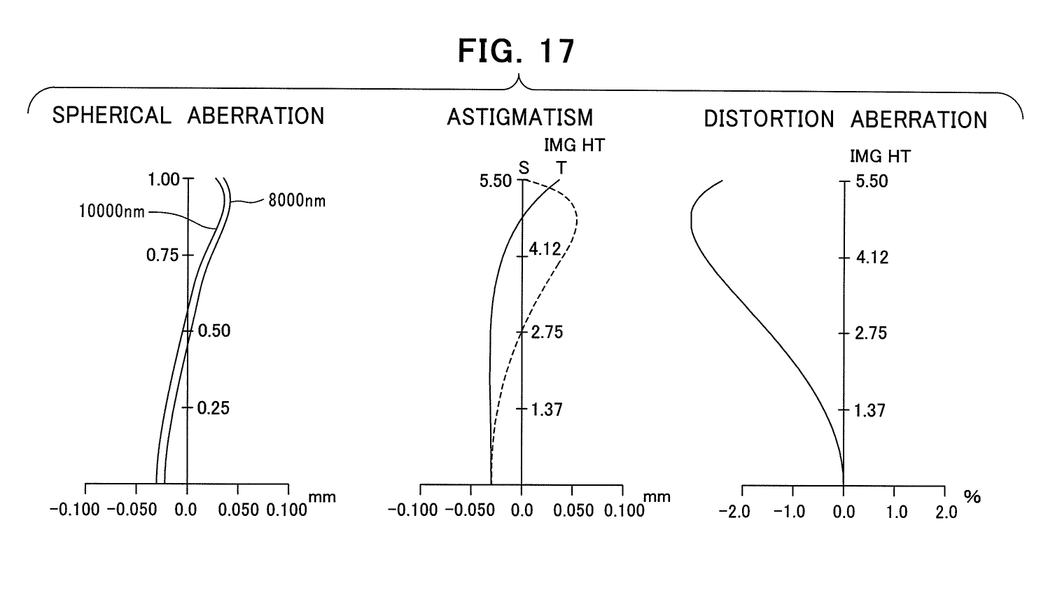

FIG. 18 is graphs on spherical aberration, astigmatism, and distortion aberration in the sixth preferred embodiment of the infrared zoom lens at telephoto.

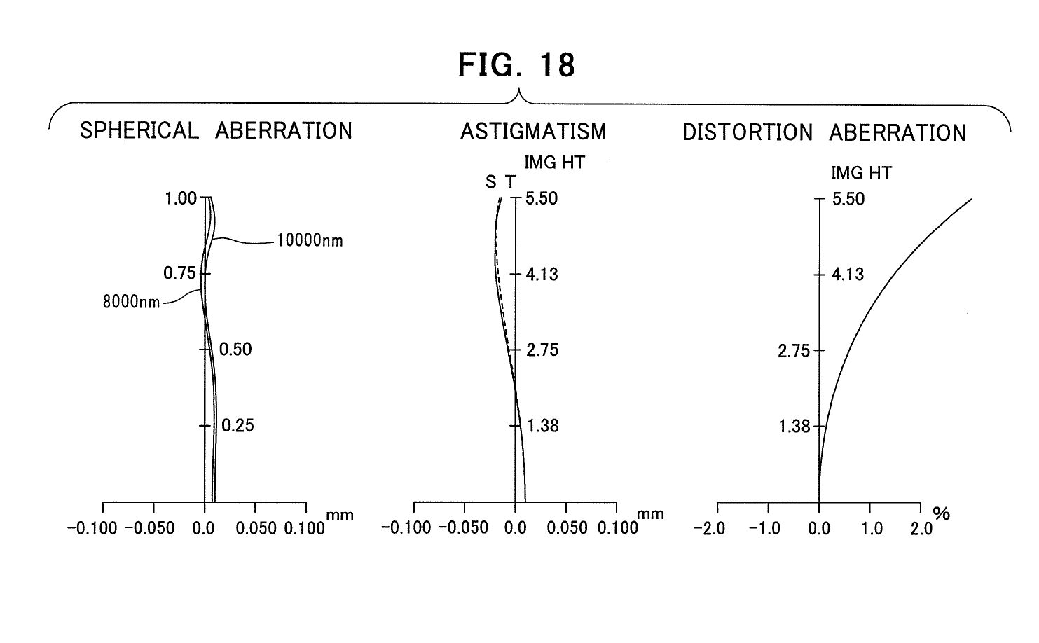

### BEST MODE OF THE INVENTION

Data on preferred embodiments of an infrared zoom lens according to the present invention will be set forth below.

Any of numbers identifying lens surfaces prefixed with an asterisk (*) denotes an aspherical surface. A formula representing the aspherical surface is given as follows:

$$X = \frac{{H}^{2} / R}{1 + \sqrt{1 - ( ɛ {H}^{2} / {R}^{2} )}} + {AH}^{2} + {BH}^{4} + {CH}^{6} + {DH}^{8} + {EH}^{10}$$

where H is a height of the aspherical surface from and perpendicular to the optical axis, X(H) is a varied amount of the height H relative to a varied departure with the apex of the aspherical surface at the origin, R is a paraxial radius of curvature, ε is a conic constant, A is the second order aspheric coefficient, B is the fourth order aspheric coefficient, C is the sixth order aspheric coefficient, D is the eighth order aspheric coefficient, and E is the tenth order aspheric coefficient.

### Embodiment 1

| | | Interval | | |
|---|---|---|---|---|
| | Curvature | between | | |
| | of Radius | Surfaces | Lens | |
| Surface# | (R) | (D) | Material | Radius |
| 1 | 129.860 | 9 | Ge | 50 |
| *2 | 209.503 | D2 | | 48.55 |
| *3 | −117.514 | 4.5 | Ge | 11.8 |
| *4 | 93.231 | D4 | | 11.7 |
| *5 | 48.736 | 4 | Chalcogenide | 13 |
| *6 | 66.843 | D6 | | 12.89 |
| 7 | 60.302 | 6 | Ge | 19.9 |
| *8 | 230.000 | D8 | | 19.2 |
| 9 | Infinity | 1 | Ge | 14.6 |
| 10 | Infinity | 18 | | 14.5 |
| IMG | | | | 5.6 |

| Sur- | | | | | |
|---|---|---|---|---|---|
| face# | ε | A | B | C | D |
| 2 | 1.5871 | −3.3872E−09 | −2.5445E−13 | | |
| 3 | 40.5900 | −2.7187E−06 | 1.6941E−08 | 6.8915E−12 | |
| 4 | −35.7490 | −3.1144E−06 | 7.4815E−09 | −9.1290E−12 | |
| 5 | −1.1259 | 1.4892E−08 | 4.8013E−09 | −7.9306E−11 | |
| 6 | 4.5758 | 3.5943E−07 | −3.6522E−09 | −7.3554E−11 | |
| 8 | 1.5048 | 9.4066E−07 | −2.7340E−10 | 2.2097E−13 | |

| | Focal | | | | | |
|---|---|---|---|---|---|---|
| | Length | Fno | D2 | D4 | D6 | D8 |
| WIDE | 35.00 | 1.01 | 57.15 | 23.02 | 34.47 | 12.80 |
| TELE | 105.00 | 1.04 | 75.17 | 5.00 | 37.33 | 9.94 |

*Aspheric Coefficient

### Embodiment 2

| | | Interval | | |
|---|---|---|---|---|
| | Curvature | between | | |
| | of Radius | Surfaces | Lens | |
| Surface# | (R) | (D) | Material | Radius |
| 1 | 137.576 | 9 | Ge | 50 |
| *2 | 226.090 | D2 | | 48.6 |
| *3 | −158.358 | 3 | Ge | 15.8 |
| *4 | 136.825 | D4 | | 15.5 |
| *5 | 56.757 | 4 | Chalcogenide | 17 |
| **6 | 90.000 | D6 | | 16.9 |
| 7 | 69.083 | 6.5 | Ge | 20 |
| *8 | 220.000 | D8 | | 19.2 |
| 9 | Infinity | 1 | Ge | 14.3 |
| 10 | Infinity | 18 | | 14.2 |
| IMG | | | | 5.5 |

| Surface# | ε | A | B | C | D |
|---|---|---|---|---|---|
| 2 | 1.6125 | −6.2211E−09 | 4.7033E−14 | | |
| 3 | 37.599 | 5.2441E−07 | 4.2633E−09 | −1.9950E−12 | |
| 4 | −51.3708 | 1.0326E−06 | 1.1138E−09 | −2.4400E−12 | |
| 5 | 57.7571 | −6.5702E−01 | 1.4310E−07 | 4.1006E−09 | −3.7839E−11 |
| **6 | 14.5889 | −4.9879E−07 | 1.7769E−11 | −4.3812E−11 | |
| 8 | 10.1997 | 3.6484E−07 | −9.3635E−11 | 1.4039E−13 | |

| Surface# | C1 | C2 | C3 | C4 | C5 |
|---|---|---|---|---|---|
| 6 | −2.1058E−04 | −2.6588E−07 | 3.1175E−09 | −1.2027E−11 | 1.6975E−14 |

| | Focal | | | | | |
|---|---|---|---|---|---|---|
| | Length | Fno | D2 | D4 | D6 | D8 |
| WIDE | 35.00 | 1 | 44.29 | 30.59 | 36.02 | 14.98 |
| TELE | 105.00 | 1.02 | 69.88 | 5.00 | 39.88 | 11.12 |

*Aspheric Coefficient
**Phase Difference Function

### Embodiment 3

| | | Interval | | |
|---|---|---|---|---|
| | Curvature | between | | |
| | of Radius | Surfaces | Lens | |
| Surface# | (R) | (D) | Material | Radius |
| 1 | 50.325 | 5 | Chalcogenide | 16.2 |
| *2 | 63.906 | D2 | | 15.1 |
| *3 | −100.000 | 2 | Ge | 11.1 |
| *4 | 250.000 | D4 | | 10.4 |
| *5 | 44.075 | 3 | Ge | 7.8 |
| *6 | 51.207 | D6 | | 8.1 |
| 7 | 55.215 | 3 | Ge | 11.7 |
| *8 | 250.000 | D8 | | 11.5 |
| 9 | Infinity | 1 | Ge | 9.8 |
| 10 | Infinity | 18 | | 9.7 |
| IMG | | | | 5.55 |

| Surface# | ε | A | B | C | D |
|---|---|---|---|---|---|
| 2 | −2.4941 | 1.8829E−06 | 3.1948E−10 | 5.0948E−12 | −1.6133E−14 |
| 3 | −305.3621 | 7.7601E−05 | −3.5613E−07 | 7.1843E−10 | 6.5777E−13 |
| 4 | 456.1135 | 1.0780E−04 | −6.1701E−07 | 2.1689E−09 | −4.4618E−12 |
| 5 | −27.0589 | −3.1559E−05 | −6.3669E−07 | 2.6800E−09 | −1.4342E−11 |
| 6 | −25.8119 | −6.0196E−05 | −4.4360E−07 | 2.9057E−09 | −1.0992E−11 |
| 8 | 285.6772 | 1.0684E−06 | −1.7327E−08 | 1.0831E−10 | −5.2025E−13 |

| | Focal | | | | | |
|---|---|---|---|---|---|---|
| | Length | Fno | D2 | D4 | D6 | D8 |
| WIDE | 14.00 | 1.58 | 2.00 | 26.41 | 22.49 | 7.49 |
| TELE | 40.00 | 1.89 | 27.31 | 1.10 | 13.17 | 16.81 |

*Aspheric Coefficient

### Embodiment 4

| | | Interval | | |
|---|---|---|---|---|
| | Curvature | between | | |
| | of Radius | Surfaces | Lens | |
| Surface# | (R) | (D) | Material | Radius |
| 1 | 81.000 | 5 | Ge | 22 |
| *2 | 149.163 | D2 | | 29.4 |
| *3 | −93.111 | 2 | Chalcogenide | 10.2 |
| *4 | 34.791 | D4 | | 10.1 |
| *5 | 37.648 | 3 | Ge | 6.8 |
| *6 | 42.668 | D6 | | 6.8 |
| *7 | 49.284 | 3 | Ge | 14 |
| *8 | 446.733 | D8 | | 13.8 |
| 9 | Infinity | 1 | Ge | 13.3 |
| 10 | Infinity | 17 | | 13.2 |
| IMG | | | | 5.5 |

| Surface# | ε | A | B | C | D |
|---|---|---|---|---|---|
| 2 | −21.9370 | 8.0840E−07 | −2.0178E−10 | −2.0847E−14 | 3.6248E−17 |
| 3 | 48.6414 | 6.9671E−06 | 6.9905E−08 | −4.3726E−11 | −2.8296E−13 |
| 4 | 2.6092 | −1.2957E−05 | 5.6337E−08 | −4.0771E−10 | −5.2445E−13 |
| 5 | −17.5226 | 4.7269E−06 | −3.5057E−07 | 9.6108E−11 | 8.7207E−13 |
| 6 | −2.9312 | −3.3469E−05 | −2.0281E−07 | 5.7845E−11 | 1.1728E−12 |
| 7 | 0.7458 | −2.2852E−07 | −1.3111E−09 | −1.2064E−11 | −6.6400E−16 |
| 8 | 153.8143 | 2.1021E−06 | −5.4490E−09 | 7.0433E−12 | −3.4468E−14 |

| | Focal | | | | | |
|---|---|---|---|---|---|---|
| | Length | Fno | D2 | D4 | D6 | D8 |
| WIDE | 14.00 | 1.41 | 13.81 | 24.80 | 20.61 | 2.64 |
| TELE | 40.00 | 1.39 | 30.05 | 8.56 | 21.67 | 1.58 |

*Aspheric Coefficient

### Embodiment 5

| | | Interval | | |
|---|---|---|---|---|
| | Curvature | between | | |
| | of Radius | Surfaces | Lens | |
| Surface# | (R) | (D) | Material | Radius |
| 1 | 74.705 | 5 | Ge | 24 |
| *2 | 151.094 | D2 | | 23.2 |
| *3 | −78.563 | 2 | Ge | 8.45 |
| *4 | 64.627 | D4 | | 8.1 |
| *5 | 38.289 | 3 | Chalcogenide | 6.4 |
| *6 | 60.000 | D6 | | 6.65 |
| 7 | 40.965 | 3 | Ge | 10 |
| *8 | 200.000 | D8 | | 9.8 |
| 9 | Infinity | 1 | Ge | 9.5 |
| 10 | Infinity | 18 | | 9.4 |
| IMG | | | | 5.5 |

| Surface# | ε | A | B | C | D |
|---|---|---|---|---|---|
| 2 | 2.6559 | −1.2550E−08 | 7.9359E−11 | −3.6953E−14 | |
| 3 | 23.9916 | −7.6721E−06 | 2.4985E−07 | −2.1738E−10 | −4.3387E−13 |
| 4 | −53.0855 | 4.9219E−06 | −1.2179E−08 | 2.6040E−09 | −8.0655E−12 |
| 5 | −7.0368 | −1.1579E−04 | −6.0702E−07 | 1.7058E−09 | −3.9319E−11 |
| 6 | 3.7007 | −1.4238E−04 | −1.5352E−07 | −2.1145E−09 | 1.3257E−11 |
| 8 | −6.8930 | 5.5952E−06 | −3.0373E−09 | −9.3494E−13 | 2.4280E−15 |

| | Focal | | | | | |
|---|---|---|---|---|---|---|
| | Length | Fno | D2 | D4 | D6 | D8 |
| WIDE | 14.00 | 1.37 | 12.77 | 15.35 | 16.57 | 1.83 |
| TELE | 40.00 | 1.37 | 25.62 | 2.50 | 16.53 | 1.87 |

*Aspheric Coefficient

### Embodiment 6

| | | Interval | | |
|---|---|---|---|---|
| | Curvature | between | | |
| | of Radius | Surfaces | Lens | |
| Surface# | (R) | (D) | Material | Radius |
| 1 | 80.296 | 5 | Ge | 22 |
| *2 | 176.430 | D2 | | 21.2 |
| *3 | −65.872 | 2 | Ge | 8.2 |
| *4 | 76.818 | D4 | | 7.9 |
| *5 | 38.496 | 3 | Chalcogenide | 6.9 |
| **6 | 80.000 | D6 | | 7.3 |
| 7 | 42.266 | 3 | Ge | 11.8 |
| *8 | 170.000 | D8 | | 11.5 |
| 9 | Infinity | 1 | Ge | 11.3 |
| 10 | Infinity | 18 | | 11.2 |
| IMG | | | | 5.5 |

| Surface# | ε | A | B | C | D |
|---|---|---|---|---|---|
| 2 | 2.2161 | 6.4536E−08 | 4.8216E−11 | −1.2464E−14 | |
| 3 | 16.1416 | 1.3224E−05 | 1.1279E−07 | −2.4556E−10 | |
| 4 | −24.7146 | 5.6460E−06 | 8.4198E−08 | | |
| 5 | 0.3371 | −8.4511E−05 | −4.3767E−07 | −2.8634E−09 | |
| **6 | 31.4250 | −9.1168E−05 | −5.0625E−07 | | |
| 8 | 53.4449 | 3.3326E−06 | −2.5801E−09 | −8.9686E−13 | |

| Surface# | C1 | C2 | C3 | C4 | C5 |
|---|---|---|---|---|---|
| 6 | −3.8744E−04 | −1.0541E−07 | 3.9914E−08 | −4.8084E−10 | |

| | Focal | | | | | |
|---|---|---|---|---|---|---|
| | Length | Fno | D2 | D4 | D6 | D8 |
| WIDE | 14.00 | 1.39 | 12.26 | 17.07 | 17.58 | 1.08 |
| TELE | 40.00 | 1.39 | 25.33 | 4.00 | 17.00 | 1.66 |

*Aspheric Coefficient
**Phase Difference Function

1. An infrared lens comprising first to fourth lens elements arranged in series from the foremost position closest to the object; each of the lens element being of a single lens piece, and at least one of the first to fourth lens elements being made of chalcogenide.

2. An infrared lens having first to fourth lens elements arranged in series from the foremost position closest to the object; each of the first to fourth lens elements being of a single lens piece, at least one of the first to fourth lens elements being made of chalcogenide that meets requirements as defined in the following formulae:
2.4≦N≦3.9
where N is a refractive index of the chalcogenide for incident light ranging from 8 to 12 μm in wavelength.

3. The infrared lens according to claim 1, wherein the first lens element is of positive refractivity, the second lens element is of negative refractivity, and the third lens element is of positive refractivity.

4. The infrared lens according to claim 1, wherein the fourth lens element is of positive refractivity.

5. The infrared lens according to claim 1, wherein the first lens element is a positive meniscus lens.

6. The infrared lens according to claim 1, wherein the third lens element is a positive meniscus lens.

7. The infrared lens according to claim 1, wherein the fourth lens element is a positive meniscus lens.

8. The infrared lens according to claim 1, wherein at least one of the major surfaces of the lens elements is a diffractive surface.

9. The infrared lens according to claim 8, wherein the third lens element has at least one of its major surfaces formed in the diffractive surface.

10. The infrared lens according to claim 1, wherein the first lens element stays still while the second lens element and the succeeding and trailing lens elements are moved in order to vary a magnification rate.

11. The infrared lens according to claim 1, wherein the first and third lens elements stay still while the second and fourth lens elements are moved in order to vary a magnification rate.

12. The infrared lens according to claim 1, wherein the fourth lens element is moved for the focusing.

13. The infrared lens according to claim 2, wherein the first lens element is of positive refractivity, the second lens element is of negative refractivity, and the third lens element is of positive refractivity.

14. The infrared lens according to claim 2, wherein the fourth lens element is of positive refractivity.

15. The infrared lens according to claim 2, wherein the first lens element is a positive meniscus lens.

16. The infrared lens according to claim 2, wherein the third lens element is a positive meniscus lens.

17. The infrared lens according to claim 2, wherein the fourth lens element is a positive meniscus lens.

18. The infrared lens according to claim 2, wherein at least one of the major surfaces of the lens elements is a diffractive surface.

19. The infrared lens according to claim 18, wherein the third lens element has at least one of its major surfaces formed in the diffractive surface.

20. The infrared lens according to claim 2, wherein the first lens element stays still while the second lens element and the succeeding and trailing lens elements are moved in order to vary a magnification rate.

21. The infrared lens according to claim 2, wherein the first and third lens elements stay still while the second and fourth lens elements are moved in order to vary a magnification rate.

22. The infrared lens according to claim 2, wherein the fourth lens element is moved for the focusing.
